(19) United States
(12) Patent Application Publication
(10) Pub. No.: US 2018/0013183 A1
(43) Pub. Date: Jan. 11, 2018

(54) BATTERY WITH THERMAL INSULATION

(71) Applicant: Robert Bosch GmbH, Stuttgart (DE)

(72) Inventor: Volker Doege, Dischingen (DE)

(21) Appl. No.: 15/544,191

(22) PCT Filed: Jan. 18, 2016
(86) PCT No.: PCT/EP2016/050896

§ 371 Date: Jul. 17, 2017

(30) Foreign Application Priority Data
Feb. 10, 2015 (DE) 10 2015 202 339.7

(51) Int. Cl. H01M 10/658; H01M 10/615; H01M 2/10; H01M 10/42

(52) U.S. Cl. CPC H01M 10/658; H01M 10/425; H01M 10/615; H01M 2/1094; H01M 2010/4278

(57) ABSTRACT

A high-temperature battery having at least one battery module, a battery housing, and at least one thermal insulating element, the battery housing and the thermal insulating element surrounding the battery module, and at least one connecting element for connecting the battery to external devices. The connecting element is realized as at least one first transponder inside the thermal insulating element, whereby a transmission of electrical energy and/or data can be carried out wirelessly between the first transponder and at least one second transponder outside the thermal insulating element.

### FIELD

The present invention relates to a battery, and to a method for transmitting electrical energy and/or data from a battery to an external device.

### BACKGROUND INFORMATION

Batteries having an elevated temperature level have numerous advantages in comparison with conventional lithium-ion batteries. Examples of this are lithium-metal polymer batteries or sodium-nickel-chloride batteries, which, compared to for example lithium-ion batteries, are more cost-efficient, and have advantages with regard to specific energy content, or also with regard to safety. The increased temperature level enables adequately large conductivities of the involved cell components (for example electrolyte, protective layers) and adequately large exchange current densities in connection with the electrochemical cell reactions that are involved.

In general, batteries having an increased temperature level also require a temperature design, because during operation heat is generated that may be greater than the thermal losses in the system, and in general specific temperature limits of the cells must also be observed. Depending on the temperature level and operating strategy, a more or less expensive thermal insulation of the battery cells is required in order to keep the heat losses low and to keep the required heating power as small as possible. Here, conductors, mechanical supports, and other heat bridges, including radiation losses, always represent possible thermal leaks. The insulating effect of the thermal insulating layer is mostly based on exploitation of the good insulating properties of gas or vacuum cavities.

In particular when the batteries are used in vehicles, during the useful life of the battery when it is out of operation, or is in only limited operation (for example a parking vehicle), a heating unit is always required (for the heating of the battery) in order to be ready for further operation of the battery. This costs energy, and may deplete the battery. Here, the quality of the thermal insulation is particularly important. Current-conducting, voltage-conducting, and signal-conducting cables are always also thermally conductive connections to the surrounding environment of the battery, which cause significant thermal losses at the battery which cannot be completely prevented even by a good thermal insulation.

German Patent Application No. DE 10 2011 118 287 A1 describes a charging device for charging and discharging a motor vehicle battery in which energy from an external charging station is transmitted wirelessly to a vehicle-internal energy receiving unit, from where the energy is conducted to the vehicle battery via further cables. Correspondingly, the electrical power is conducted via cables through the thermal insulation of the vehicle battery, resulting in thermal bridges on the path from the battery cell to the battery housing.

### SUMMARY

The present invention provides a battery and a method for transmitting electrical energy and/or data from the battery to an external device. Features and details of the present invention are described herein and are shown in the figures. Here, features and details that are described in connection with the battery according to the present invention also of course hold in connection with the method according to the present invention and vice versa, so that the disclosure of the individual aspects of the present invention can always be understood as applying to both.

According to the present invention, the battery has at least one battery module, a battery housing, and at least one thermal insulating element, the battery housing and the thermal insulating element surrounding the battery module. In addition, the battery has a connecting element for connecting the battery to an external device. In accordance with the present invention that the connecting element is realized as at least one first transponder inside the thermal insulating element, preferably in or on the battery module, whereby a transmission of electrical energy and/or data can be carried out wirelessly between the first transponder and at least one second transponder outside the battery housing, or on the battery housing, at least beyond the internal compartment of the thermal insulating element. Thus, at least the first and second transponder form the connecting element according to the present invention.

In the sense of the present invention, batteries can be understood as electrical storage devices (such as double-layer storage), electrochemical storage devices, energy storage devices based at least in part on a physical principle (e.g. double-layer), and/or hybrid storage designs (electrical and electromechanical, etc., in a cell housing, module housing, or pack housing); only some of the mentioned energy storage devices may require an elevated temperature level. In particular, the present invention relates to rechargeable electric storage devices, electrochemical storage devices, and hybrid storage designs having (partly) temperature-sensitive performance, and preferably to accumulators, i.e., rechargeable batteries. A transponder according to the present invention can here be used for the transmission of data and/or electrical energy, so that in the context of the present invention a transponder for data and a transponder for electrical energy or a transponder for electrical energy and data can be used. Through the wireless transmission of electrical energy and/or data via the thermal insulation path, the thermal losses otherwise resulting from cable conductors are reduced. In particular given cable conductors made of copper or aluminum, which have a high thermal conductance value, the efficiency of the battery is reduced by the thermal losses. Accordingly, the battery housing and the thermal insulating element can be sealed in such a way that no routed-through cables for data transmission and/or electrical energy transmission are present. Correspondingly, the routing through of electrical conductors for energy and/or data transmission, as are provided in the existing art, can be omitted. In this way, an optimal effect of the thermal insulating element can be achieved. In the sense of the present invention, data transmission means that signals ascertained either digitally or in analog fashion can be transmitted from and to the battery. In general, the battery also has its own electronics/electrical system on board, with which for example balancing or also heating/tempering can be carried out. The two transponders according to the present invention stand opposite one another in the broadest sense, so that a maximally optimal charge covering of the two transponders can be realized. At least one thermal insulating element can be situated in or on the housing in order to achieve thermal separation. Here, it is possible that a thermal insulating element according to the present invention can be situated on the housing inner wall or housing outer wall, as well as between the battery modules. In addition to the previously mentioned insulating materials, other standard materials suitable for use can also be used. Thus, for example a plastic insulation in or on the battery housing is possible, which can also be realized as foam in the form of plastic-organic foam, here preferably polyethylene, polystyrene, Neopor, polyurethane, or resol foam. In addition, mineral fibers, such as mineral wool and glass wool, are also possible for use as thermal insulation according to the present invention. Particularly advantageous due to their poor thermal conductivity are aerogel mats and vacuum insulating boards. Due to the finite thermal conductivity of the thermal insulating elements, with the use according to the present invention of transponders for wireless transmission of electrical energy and/or data, at least the thermal conduction via cable and/or via mechanical support points situated between the tempered storage elements and the battery housing is prevented to the greatest possible extent.

In the context of the present invention, the transmission of the energy and/or of the data can take place electromagnetically and/or inductively and/or capacitively and/or optically. Here, the wireless transmission principle can relate to all electromagnetic transmission methods and transmission frequencies that can be routed through gas/vacuum stretches or through insulating materials that are respectively used without special transmission lines or media. For example, the use of near-range communication techniques such as infrared diodes and IR-LEDs suggests itself. Such components can always also be part of integrated components. There are also components that can act both as LED (or laser or broadband sources) and as photodiodes, such as bidirectional chips or special LEDs. In general, the photo-optical range up to UV is also a possible frequency range for components having diode-type functioning. Other photodetectors and emitters for UV/IS/IR are also possible in the context of the present invention. If the transponders according to the present invention are used both for a transmission of the electrical energy and for the data transmission, then for example the transponder can be a carrier frequency apparatus that modulates a data signal for or from the connected device into a radio-frequency range, and is demodulated by or for the second transponder. Here, both a one-sided/unidirectional and also a bidirectional transmission of the energy and/or data are possible.

According to the present invention, it is possible that the first transponder and/or the second transponder has at least one coil and/or a light source and/or a sensor and/or a capacitor plate. Through the use of a coil, an electromagnetic induction between the two transponders, each fashioned as a coil, can be used for the transmission of electrical energy and/or data. Preferably, the transmission path between the transponders is free of materials that absorb electromagnetic radiation (e.g. if a metallic housing in the area of the transmission path has openings with or without other material, such as glass or plastic (non-conductive)), in order to avoid energy losses in the inductive transmission based on coils. For an optical transmission, at least one light source is required that in particular however is not exclusively used for the transmission of, as a rule, digital data via light; rather, electrical energy can also be transmitted. Here as well, the housing and/or the insulating element should have light-transparent regions for the transmission, e.g., made of glass or plastic. Here, LED technology or laser technology is possible. The advantages of an optical transmission via light sources are the rapid construction, a high degree of data security, high bitrates, and low interference problems, or low influence of the Fresnel zone. In the case of capacitive data and/or energy transmission, a transponder respectively forms at least one capacitor plate. Preferably, this transmission path between the transponders is also free of materials that absorb electromagnetic radiation, as already mentioned above.

A combination of different transmission designs, as mentioned in the last two paragraphs, is also possible. Thus, for example the data can be transmitted, using a different transmission design, as electrical energy, for example by light, while the electrical energy is transmitted by induction/coils. As already mentioned, however, the data can also be transmitted using the same transmission design as the energy; here a simultaneous or a sequential transmission is possible.

In the context of the present invention, it is possible that the first transponder has at least one first transponder electronic unit and the second transponder has at least one second transponder electronic unit whereby at least the voltage, the current, and/or the frequency of the electrical energy can be modified. This is required in particular when an alternating voltage or a modified voltage or frequency position is to be generated. This can be advantageous for linking to external devices and to the further components of the drive train of the vehicle, because a battery typically supplies direct current and further components of the drive train are operated with alternating current. Moreover, an alternating current can easily be transmitted wirelessly using induction.

In addition, it is possible that the first transponder and the second transponder can each send and receive energy, enabling a bidirectional energy transmission. Correspondingly, both transponders can act both as transmitters and as receivers. Depending on the direction of energy flow, it is possible to install in each case a separate receiver or a separate transmitter. Consequently, the battery can be not only charged but also discharged, or data can be sent from the battery to an external device or can be sent from an external device to the battery.

In the context of the present invention, it is possible that the second transponder is capable of being situated movably outside the battery housing. Through a movable situation, the charge coverage of the two transponders can be modified, so that, depending on the constructive space conditions, an optimal transmission can be ensured. This can be advantageous for example when a plurality of batteries are used in a system, or if batteries having different geometrical shapes are used. The charge coverage is particularly important in the case of an inductive transmission of electrical energy or data. Through the modified charge covering, the degree of effectiveness of the charging and/or of the discharging is influenced.

Advantageously, at least one positioning aid can be situated on the battery housing, e.g., in the form of projections, pins, recesses, or openings, that can in particular interact in complementary fashion with counter-positioning aids (e.g., on the vehicle or external device). Here, a positioning aid acts on the one hand to correctly position the battery or the battery housing in a device provided therefor (e.g., on the vehicle). In this way, destruction to the battery or the device can be prevented, and in this way the lifespan of batteries, which can be cost-intensive, can be prolonged. On the other hand, a positioning aid is used as a reverse polarity protection for the battery, and in this way destruction of the battery or of the external device can be prevented. A positioning aid can be realized in such a way that a battery housing a material recess or additional material is attached on the battery housing, thus producing a guiding aid and/or locking function. In this way, the positioning aid can simultaneously be used to fix the battery, e.g., on the vehicle or external device.

According to the present invention, it is possible that on the battery module and/or on the battery housing and/or on the thermal insulating element there is situated at least one sensor unit that can ascertain state information of the battery. The state information can for example be the temperature of the battery or of the surrounding environment and/or the state of charge of the battery and/or a load on the battery and/or a sensor for ascertaining the charge cycles. Correspondingly, via a sensor unit according to the present invention all relevant data concerning physical and/or chemical quantities of the battery or of the immediate surrounding environment of the battery can be communicated to an external device. The data obtained in this way can be further processed by the external device, whereby for example via a control unit the battery can be controlled and/or regulated, resulting in monitoring and optimization of the battery. In the case of a bidirectional transmission, the ascertained information can correspondingly be processed by a control unit, so that when parameters change, the user can carry out modifications at the battery manually or automatically.

In the context of the present invention, it is possible that the first transponder and the second transponder have a data interface for the data, Bluetooth and/or NFC and/or wireless LAN and/or GSM being used for the transmission of the data. The use of Bluetooth enables a fast and flexible connection between the battery and an external device, where the external device can also be a portable telephone of a user. The stability of Bluetooth connections has proved to be very high due to the frequent frequency jumps and small data packets. In addition, Bluetooth is distinguished by low energy consumption and low transmission power and a low sensitivity to interference. Transmission via NFC (Near Field Communication) enables a reliable and convenient transmission of the data of the battery to an external device, the security being increased in that the transmission is enabled only over a short distance, and manipulation by third parties can be prevented in this way.

Wireless LAN enables data transmission over a wireless local network, such that a large transmit power and range with a high data transmission rate can be produced. The wireless network can for example be produced by an onboard electronics system of a vehicle, or can be connected directly to an external device such as a portable telephone of a user. The transmission via the GSM network enables a large range, because this is the standard for fully digital radiotelephone networks used for line-switched and packet-switched data transmission. Correspondingly, the data can be sent over a large range to external devices, for example portable telephones, or computers, so that for example maintenance intervals or state data can be communicated to the user or to a workshop or to the battery manufacturer. Consequently, in this way it can be communicated to the user by a workshop or by the manufacturer that the battery being used is defective and should be exchanged.

According to a further aspect of the present invention, a method is provided for transmitting energy and/or data of a battery to an external device. Here, the battery has at least one battery module, a battery housing, and at least one thermal insulating element, the battery housing and the thermal insulating elements surrounding the battery module and at least one connecting element being present for connecting the battery to an external device. Here, in accordance with the present invention, the electrical energy and/or data is capable of being transmitted wirelessly between a first transponder and at least one second transponder outside the thermal insulating element (this means outside the battery housing, or on the battery housing at least beyond the internal compartment of the thermal insulating element).

Accordingly, the described method has all the advantages already described in relation to the battery according to the present invention.

### BRIEF DESCRIPTION OF THE DRAWINGS

Further features that improve the present invention result from the following description of some exemplary embodiments of the present invention that are schematically shown in the Figures. All the features and/or advantages resulting from the description, or the figures, including constructive details, spatial configurations, and method steps, can be essential to the present invention both in themselves and also in any combination. Here it is to be noted that the Figures have only a descriptive character and are not intended to limit the present invention in any way.

FIG. 1 schematically shows a battery according to the existing art.

FIG. 2 schematically shows a first specific embodiment of the battery according to the present invention.

### DETAILED DESCRIPTION OF EXAMPLE EMBODIMENTS

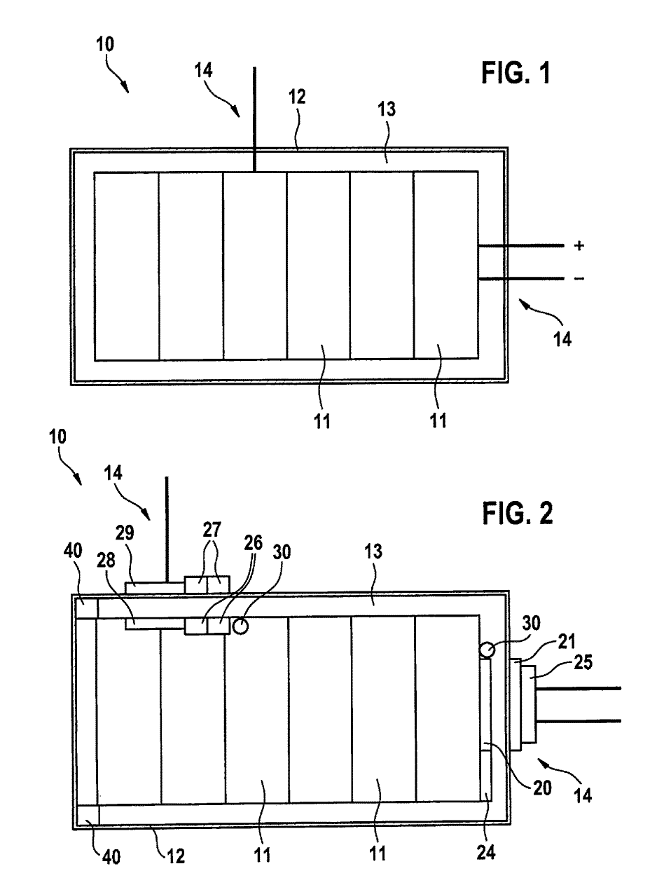

FIG. 1 schematically shows a battery according to the existing art, having a multiplicity of battery modules 11, a battery housing 12, an insulating element 13, and two connecting elements 14. The connecting elements 14 are, on the one hand, a terminal for transmitting electrical energy between battery 10 and an external device. Connecting element 14 is realized in the form of cables that run from battery modules 11 through insulating element 13 and battery housing 14, and thus run out from the battery. Connecting element 14 for the transmission of data is made up of a cable that is also routed from battery modules 11 through thermal insulating element 13 and battery housing 12. Both in the case of connecting element 14 for the transmission of electrical energy and also in the case of connecting element 14 for the transmission of data, due to the cables that are present in each case there results a thermal loss due to the thermal conduction in the connecting cables. In the transmission of electrical energy, at least two lines are required, and for the power transmission of the electrical energy more than two lines are present so that different voltage levels can be realized. Depending on the temperature level of the interior compartment of the battery, a more or less expensive thermal insulation of battery modules 11 is required in order to keep the thermal losses low and to keep the required heating power as small as possible. The routing of connecting elements 14 through thermal insulating element 13 and battery housing 12 is a thermally conductive connection to the surrounding environment of the battery, and thus represents a potential thermal leakage that, in particular when the ambient temperature around the battery is low, negatively influences the efficiency of the battery and its useful life. The influence of the temperature is particularly important in the case of storage elements that, due to temperature-sensitive performance, have to be operated at particular temperatures and that therefore already depend on a thermal insulating element 13 having a high insulating effect. The insulating effect of these thermal insulating elements 13 is mostly based on the exploitation of the good insulating properties of gas or vacuum cavities.

FIG. 2 shows a specific embodiment of battery 10 according to the present invention that has a multiplicity of battery modules 11, a battery housing 12, and at least one thermal insulating element 13, battery housing 12 and thermal insulating element 13 surrounding battery module 11. For better distinguishability and illustration of the battery according to the present invention relative to the existing art, battery 10 according to the present invention in FIG. 2 also optionally has two connecting elements 14, respectively one connecting element 14 for the transmission of electrical energy and one connecting element 14 for the transmission of data between first transponder 20, 26 and second transponder 21, 27. According to the present invention, in FIG. 2, instead of the cable through thermal insulating element 13, there are now oppositely situated transponders 20, 21 and 26, 27. Here, within the scope of the present invention it is possible that to achieve the bidirectionality of the transmission of electrical energy and/or data, transponders 20, 21, 26, 27 act both as transmitters and as receivers, or depending on the direction of energy flow a separate transponder can be installed for transmission or reception. For the operation of transponders 20, 21, 26, 27, in general a transponder electronics unit 24, 25, 28, 29 is required that, given the transmission of electrical energy, for example generates an alternating voltage for transponder 20, because battery 10 typically supplies direct current. In addition, transponder electronics 24, 25 can be used to generate a modified voltage or frequency position in order in this way to enable linkage to the external devices. This holds both for the direction of the energy flow when charging battery 10 and also during discharging or removal of energy from battery 10 by an external device. In the transmission of data, transponder electronics 28, 29 are used to achieve the bidirectionality of the data flow, transponder electronics 28, 29 being capable of acting both as transmitter and also as receiver of the data.

It is also possible here that a separate transponder 26, 27 can be installed per data flow direction. In the transmission of data, transponder electronics 28, 29 are used for example for signal conversion (electrical ⇄ optical) and for the digitization or digital preparation of signals. In the context of the present invention, data transmission means that sensor or control signals are transmitted from and to battery 10 either in analog or digital fashion. These can for example be voltage signals, temperature sensor data, or control signals for triggering the battery balancing. The data can for example be ascertained by a sensor unit 30 or by a separate electronics unit of battery 10, such that in this way a balancing or also a heating can be carried out. In order to ensure this, a bidirectional data transmission from and to the battery is required. In FIG. 2, sensor unit 30 is situated as an example on battery module 11, and can thus be prepared via transponder electronics 24, 25, 28, 29, and transmitted via transponder 20, 21, 26, 27. In addition, in FIG. 2 positioning units 40 are shown which are situated on battery housing 12 and which provide a correct positioning of battery 10. Correspondingly, positioning aid 40 also acts as a reverse polarity protection of the battery and, where required, is used for the best possible transmission of electrical energy and/or data between transponders 20, 26, 21, 27.

1-10. (canceled)

11. A high-temperature battery, comprising:
at least one battery module;
a battery housing;
at least one thermal insulating element, the battery housing and the thermal insulating element surrounding the battery module; and
at least one connecting element for connecting the battery to external devices, the connecting element including at least one first transponder inside the thermal insulating element, whereby a transmission of at least one of electrical energy and data can be carried out wirelessly between the first transponder and at least one second transponder outside the thermal insulating element.

12. The battery as recited in claim 11, wherein the transmission of the at least one of the energy and the data takes place at least one of: (i) electromagnetically, (ii) inductively, (iii) capacitively, and (iv) optically.

13. The battery as recited in claim 11, wherein at least one of the first transponder and the second transponder has at least one of: (i) a coil, (ii) a light source, (iii) a sensor, and (iv) a capacitor plate.

14. The battery as recited in claim 11, wherein at least one of: (i) the first transponder has at least one first transponder electronics whereby at least a voltage, a current, and a frequency of the electrical energy can be modified, and (ii) the second transponder has at least one second transponder electronics whereby at least a voltage, a current, and a frequency of the electrical energy can be modified.

15. The battery as recited in claim 11, wherein the first transponder and the second transponder can each transmit and receive the at least one of the energy and the data, whereby at least one of a bidirectional energy and a data transmission is enabled.

16. The battery as recited in claim 11, wherein the second transponder is situated movably outside the thermal insulating element.

17. The battery as recited in claim 11, wherein at least one positioning aid for the battery module is situated on the battery housing.

18. The battery as recited in claim 11, wherein at least one sensor unit is situated at least one of: (i) on the battery module, (ii) on the battery housing, (iii) on the thermal insulating element, with which sensor unit state information of the battery can be ascertained.

19. The battery as recited in claim 11, wherein the first transponder and the second transponder have a data interface for the data, and wherein at least one of Bluetooth, NFC, wireless LAN, and GSM being used for the transmission of the data.

20. A method for transmitting at least one of energy and data of a battery to an external device, the battery including at least one battery module, a battery housing, and at least one thermal insulating element, the battery housing and the thermal insulating element surrounding the battery module, and at least one connecting element for connecting the battery to external devices, the at least one connecting element including a first transponder inside the thermal insulating element, the method comprising:
wirelessly transmitting at least one of electrical energy and data, between the first transponder and at least one second transponder outside the thermal insulating element.
